(19) United States
(12) Patent Application Publication
(10) Pub. No.: US 2009/0254945 A1
(43) Pub. Date: Oct. 8, 2009

(54) PLAYBACK APPARATUS, PLAYBACK METHOD, PROGRAM, RECORDING MEDIUM, SERVER, AND SERVER METHOD

(75) Inventors: Akihiko Kinoshita, Tokyo (JP); Shinobu Hattori, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/397,623

(22) Filed: Mar. 4, 2009

(30) Foreign Application Priority Data
Apr. 8, 2008 (JP) 2008-100235

(51) Int. Cl. H04N 5/445; H04N 7/173; H04N 5/91

(52) U.S. Cl. 725/60; 725/116; 725/134; 386/46

(57) ABSTRACT

A playback apparatus that communicates with a server and plays back data of a content item in accordance with a control file sent from the server includes a medium-information obtaining unit that obtains medium specifying information specifying a recording medium inserted into the medium-information obtaining unit; a playback-mode specifying unit that specifies a playback mode of a content item recorded on the recording medium; a sending unit that sends the medium specifying information and information specifying the playback mode to the server; and a playback control unit that receives a control file sent by the server in accordance with the sent medium specifying information and the sent information specifying the playback mode and controls playback of the content item recorded on the recording medium in accordance with the control file.

### BACKGROUND OF THE INVENTION

1. Field of the Invention

The present invention relates to a playback apparatus, a playback method, a program, a recording medium, a server, and a server method. The present invention relates more particularly to a playback apparatus, a playback method, a program, a recording medium, a server, and a server method that are capable of realizing a sales channel which has a higher degree of flexibility and which can more powerfully convey detailed information.

2. Description of the Related Art

So-called television shopping has been becoming popular, in which products are introduced in a television program and viewers are allowed to place orders for the products. Moreover, mail order has been used in which catalogues are handed out or sent to consumers and they are allowed to place orders for products. Furthermore, Internet shopping has been becoming popular in which display of product information, placing orders for products, processing for making payments for the products, and the like are performed via the Internet.

Moreover, a technology capable of suppressing the cost of communication and conveying product information has been proposed by distributing product-catalogue data including image data, moving-image data, and audio data from a product management server to a customer terminal using e-mail and by playing back the product-catalogue data using an e-mail software program and automatically updating the product-catalogue data, the playing back and updating being performed by the customer terminal (for example, see Japanese Unexamined Patent Application Publication No. 2002-229895).

### SUMMARY OF THE INVENTION

However, so-called television shopping has a problem in that if a television program which is broadcasted at a predetermined time period is not viewed, orders for products are not placed, whereby cost effectiveness is low.

Moreover, mail order has a problem in that mail order does not adequately convey product details and maintain information freshness.

In contrast, Internet shopping can sell products regardless of time frame and can maintain information freshness. However, for example, it is difficult to provide high-quality content regarding images of a product to be introduced because of the constraints of a network transmission speed. Thus, in comparison with, for example, so-called television shopping, Internet shopping does not adequately convey product details.

The present invention has been made in light of such circumstances and it is desirable to realize a sales channel which has a higher degree of flexibility and which can more powerfully convey product details.

A playback method according to an embodiment of the present invention is a playback method for playing back data of a content item recorded on a recording medium in accordance with a control file sent from a server through communication, the playback method including the steps of: obtaining medium specifying information specifying the recording medium; specifying a playback mode of a content item recorded on the recording medium; sending the medium specifying information and information specifying the playback mode to the server; and receiving a control file sent by the server in accordance with the sent medium specifying information and the sent information specifying the playback mode and controlling playback of the content item recorded on the recording medium in accordance with the control file.

A plurality of content items for introducing products or services may be recorded on the recording medium, and playback of the content items may be controlled in a predetermined playback order or at a predetermined playback position in accordance with the control file sent from the server.

The step of sending information specifying a product or a service for which an order is placed, to the server through a network in accordance with a user command may further be included.

A control file generated in accordance with a purchase history of a user regarding the products and services may be received from the server, the user being associated with the medium specifying information, and playback of the content items recorded on the recording medium may be controlled in accordance with the control file.

A playback apparatus according to the embodiment of the present invention is a playback apparatus that communicates with a server and plays back data of a content item in accordance with a control file sent from the server, the playback apparatus including: medium-information obtaining means for obtaining medium specifying information specifying a recording medium inserted into the medium-information obtaining means; playback-mode specifying means for specifying a playback mode of a content item recorded on the recording medium; sending means for sending the medium specifying information and information specifying the playback mode to the server; and playback control means for receiving a control file sent by the server in accordance with the sent medium specifying information and the sent information specifying the playback mode and controlling playback of the content item recorded on the recording medium in accordance with the control file.

A recording medium according to an embodiment of the present invention is a recording medium on which data of a content item to be played back by a playback apparatus and a program for causing the playback apparatus to execute processing for playing back the content item are recorded, the program including the steps of: obtaining and sending medium specifying information specifying the recording medium and information specifying a playback mode of a content item recorded on the recording medium, to the server via the playback apparatus; and causing the playback apparatus to receive a control file sent by the server in accordance with the sent medium specifying information and the sent information specifying the playback mode and execute processing for playing back the content item recorded on the recording medium in accordance with the control file.

According to the embodiments of the present invention, the medium specifying information specifying the recording medium is obtained. The playback mode of the content item recorded on the recording medium is specified. The medium specifying information and information specifying the playback mode are sent to the server. The control file sent by the server in accordance with the sent medium specifying information and the sent information specifying the playback mode is received. Playback of the content item recorded on the recording medium is controlled in accordance with the control file.

A server according to an embodiment of the present invention is a server for supplying a control file for controlling playback of a content item to a playback apparatus into which a recording medium on which the content item is recorded is inserted, the server including: obtaining means for obtaining medium specifying information specifying the recording medium and information specifying a playback mode of the content item that are included in information received from the playback apparatus; and sending means for sending the control file, which is appropriate for the playback apparatus, to the playback apparatus in accordance with the obtained medium specifying information and the obtained information specifying the playback mode.

A control-file supplying method according to the embodiment of the present invention is a control-file supplying method for supplying a control file for controlling playback of a content item to a playback apparatus into which a recording medium on which the content item is recorded is inserted, the control-file supplying method including the steps of: obtaining medium specifying information specifying the recording medium and information specifying a playback mode of the content item that are included in information received from the playback apparatus; and sending the control file, which is appropriate for the playback apparatus, to the playback apparatus in accordance with the obtained medium specifying information and the obtained information specifying the playback mode.

A recording medium according to the embodiment of the present invention is a recording medium on which a program is recorded, the program causing a server for supplying a control file for controlling playback of a content item to a playback apparatus into which a recording medium on which the content item is recorded is inserted, to execute the steps of: obtaining medium specifying information specifying the recording medium and information specifying a playback mode of the content item that are included in information received from the playback apparatus; and sending the control file, which is appropriate for the playback apparatus, to the playback apparatus in accordance with the obtained medium specifying information and the obtained information specifying the playback mode.

According to the embodiment of the present invention, the medium specifying information specifying the recording medium and the information specifying the playback mode of the content item are obtained, the medium specifying information and the information specifying the playback mode being included in the information received from the playback apparatus. The control file, which is appropriate for the playback apparatus, is sent to the playback apparatus in accordance with the obtained medium specifying information and the obtained information specifying the playback mode.

According to the embodiments of the present invention, a sales channel which has a higher degree of flexibility and which can more powerfully convey product details is realized.

### BRIEF DESCRIPTION OF THE DRAWINGS

FIG. 1 is a block diagram showing an exemplary structure of a network system according to an embodiment of the present invention;

FIG. 2 is a block diagram showing an example of a detailed functional structure of software such as a program executed by a control unit of a server in FIG. 1;

FIG. 3 is a diagram showing an exemplary screen displayed on a display of a terminal;

FIG. 4 is a diagram showing another exemplary screen displayed on the display of the terminal;

FIG. 5 is a diagram showing another exemplary screen displayed on the display of the terminal;

FIG. 6 is a diagram showing another exemplary screen displayed on the display of the terminal;

FIG. 7 is a diagram showing another exemplary screen displayed on the display of the terminal;

FIG. 8 is a diagram for describing generation of display data to be displayed on the screen of the display;

FIG. 9 is a sequence diagram for describing a procedure of processing for generating playlist files;

FIG. 10 is a diagram showing a group of exemplary records to be stored in a playlist DB;

FIG. 11 is a sequence diagram for describing a procedure of processing for distributing discs;

FIG. 12 is a sequence diagram for describing a procedure of processing regarding playback of content items recorded on a disc;

FIG. 13 is a sequence diagram for describing a procedure of processing in a case where the disc is played back by the terminal and an order for a product is placed;

FIG. 14 is a sequence diagram for describing a procedure of processing in a case where the disc is played back by the terminal and a content item for introducing a product is played back while a content item for introducing another product is being played back;

FIG. 15 is a flowchart for describing the details of processing performed by an application program in FIG. 12;

FIG. 16 is a flowchart for describing the details of processing performed by a server in FIG. 12;

FIG. 17 is a diagram for describing manufacture of a recording medium on which data that can be played back by the terminal is recorded;

FIG. 18 is a diagram for describing manufacture of the recording medium on which data that can be played back by the terminal is recorded; and

FIG. 19 is a block diagram showing an exemplary structure of a personal computer.

### DESCRIPTION OF THE PREFERRED EMBODIMENTS

In the following, embodiments of the present invention will be described with reference to the attached drawings.

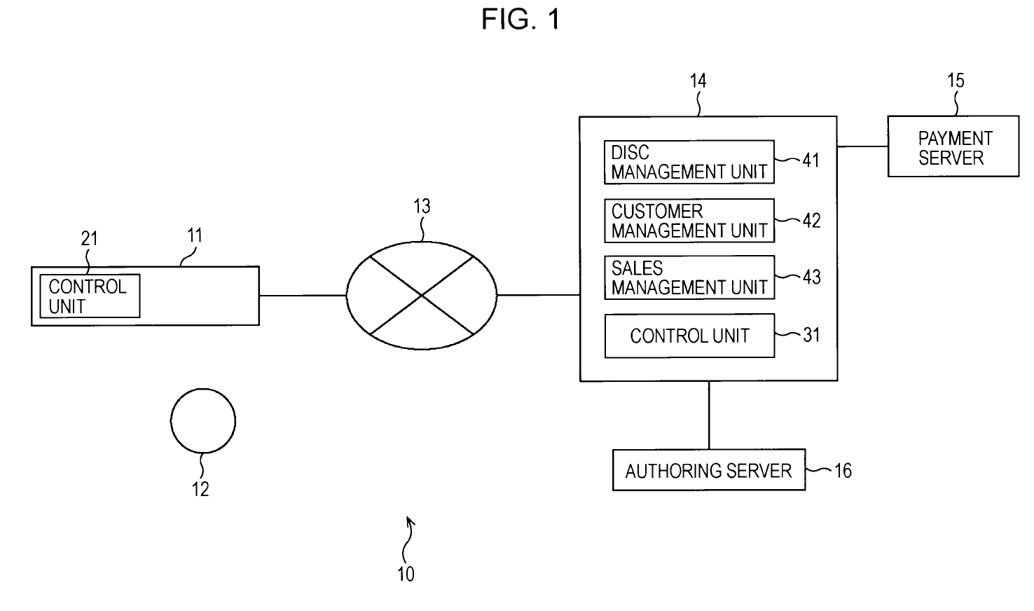

FIG. 1 is a block diagram showing an exemplary structure of a network system 10 according to an embodiment of the present invention. In the network system 10, for example, a user of a terminal 11 places an order for a product (or a service) to a server 14 of an online-shopping retailer via a network 13 such as the Internet.

A disc 12 which is provided to a user who has been registered in advance in the server 14 is inserted into the terminal 11. For example, a user of the terminal 11 performs an operation in accordance with a graphical user interface (GUI) to place an order for a product, and the server 14 receives the order for the product. Moreover, processing for making a payment for the ordered product can be provided by a payment server 15.

The terminal 11 is, for example, a Blu-ray Disc (BD) player or a BD recorder. For example, the terminal 11 may include a connection terminal for connecting to the network 13 such as the Internet.

The terminal 11 has a drive into which the disc 12 is inserted, and reads data from the disc 12 inserted into the drive. Moreover, if the disc 12 is a writable recording medium, data may be written on the disc 12 from the terminal 11.

The disc 12 is, for example, a Blu-ray Disc (registered trademark). An existing digital versatile disc (DVD) has a recording capacity of about 4.7 GB; however, a Blu-ray Disc has a recording capacity of about 25 GB, which is significantly large. Moreover, a predetermined program is recorded in advance on the disc 12. When the disc 12 is played back by the terminal 11, the program recorded on the disc 12 is executed by a control unit 21.

The program recorded in advance on the disc 12 is described in a programming language that is independent of, for example, the type of computer or OS and that is allowed to be used in the network, whereby the program can be executed regardless of manufacture or type of the terminal 11. This program may be generated by, for example, a manufacturer of the disc 12 or an online-shopping retailer.

For example, Blu-ray Discs have a more advanced navigation function for displaying content items recorded on the discs and setting a subsequent operation in response to reception of an input performed by a user, than existing DVDs and the like. This navigation function is realized by a program that is recorded on Blu-ray Discs (an example of which is the disc 12) and that is executed by the control unit 21. More specifically, various navigation functions are realized by a group of application programs called BD-J and described in the Java (registered trademark) language.

Moreover, the disc 12 is, for example, sent to a user in advance from an online-shopping retailer. For example, content including data such as a video and audio regarding a product offered via online-shopping is recorded on the disc 12.

The control unit 21 of the terminal 11 includes, for example, a processor and a memory, and controls various units of the terminal 11. The control unit 21 also controls processing regarding communication performed between the terminal 11 and the server 14 via the network 13.

The server 14 is, for example, a general-purpose computer. The server 14 includes a disc management unit 41, a customer management unit 42, and a sales management unit 43 that are functions realized by software, such as a program, which are executed by a control unit 31 including, for example, a processor and a memory.

The payment server 15 executes processing for making a payment for an ordered product in the network system 10 in accordance with data sent from the server 14.

An authoring server 16 executes processing for assigning a disc ID, content items, and an application program to each of discs 12 sent (shipped) to users, and processing for recording the disc ID on the disc 12.

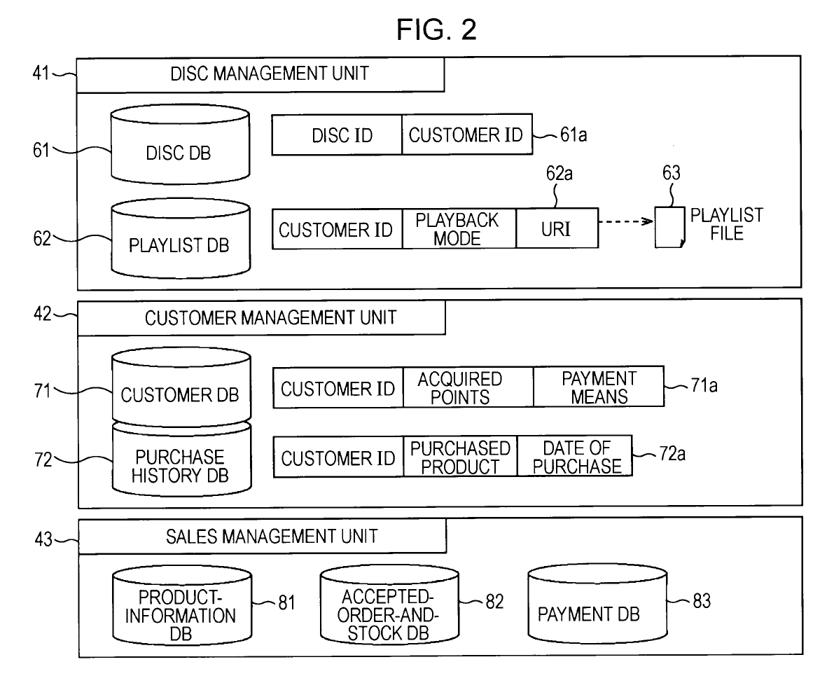

FIG. 2 is a block diagram showing an example of a detailed functional structure of software such as a program executed by the control unit 31 of the server 14. As shown in FIG. 2, the disc management unit 41, the customer management unit 42, and the sales management unit 43 perform generation and management of databases. Here, the databases shown in FIG. 2 are actually recorded on a recording medium of the server 14, the recording medium including a hard disk drive (HDD) and the like.

The disc management unit 41 generates and manages a disc database (DB) 61 and a playlist DB 62.

The disc DB 61 is a database which includes a plurality of records 61a. In this example, each of the records 61a includes a disc ID and a customer ID. That is, the disc DB 61 is a database storing the records 61a in which customer IDs specifying users and disc IDs specifying the discs 12 are associated with each other.

The playlist DB 62 is a database which includes a plurality of records 62a. In this example, each of the records 62a includes a customer ID, a playback mode, and a uniform resource identifier (URI). Here, as described below, the “playback mode” included in the record 62a is information indicating a mode specified when the disc 12 is played back by the terminal 11. Moreover, the URI included in the record 62a is information for specifying a position where a playlist file 63 is recorded. That is, the playlist DB 62 is a database storing the records 62a in which customer IDs, playback modes, and positions where playlist files 63 are recorded are associated with each other.

Each of the playlist files 63 is a file in which a playlist is described, the playlist specifying a playback order of content items recorded on the disc 12 and a playback start position and causing the terminal 11 to play back the content items in accordance with the playback start position and the playback order. That is, if the playlist file 63 is sent to the terminal 11, content items recorded on the disc 12 can be played back as specified by the playlist file 63. The playlist files 63 are generated in advance and recorded on the recording medium of the server 14 by, for example, a person responsible for operation of the server 14.

Here, the playlist in each of the playlist files 63 includes, for example, information specifying content items (for example, the IDs of products) to be played back and information such as addresses specifying positions where the content items are recorded on the disc, and causes predetermined content items recorded on the disc 12 to be played back in accordance with a predetermined order.

The customer management unit 42 generates and manages a customer DB 71 and a purchase history DB 72.

The customer DB 71 is a database which includes a plurality of records 71a. In this example, each of the records 71a includes a customer ID, acquired points, and a payment method. Here, the “acquired points” included in the record 71a are points that are, for example, given to a user from an online-shopping retailer in accordance with a product purchase status of the user. Moreover, the “payment method” included in the record 71a is information indicating a payment method specified in advance by the user corresponding to the customer ID (for example, paying by credit card, transferring money to a certain bank account, or the like). That is, the customer DB 71 is a database storing the records 71a in which customer IDs, acquired points of users corresponding to the customer IDs, and payment methods specified in advance by the users corresponding to the customer IDs are associated with each other.

The purchase history DB 72 is a database which includes a plurality of records 72a. In this example, each of the records 72a includes a customer ID, a purchased product, and the date of purchase. Here, the “purchased product” included in the record 72a is information specifying a product purchased by a user corresponding to the customer ID, and the “date of purchase” included in the record 72a is information indicating the date of purchase of the product. That is, the purchase history DB 72 is a database storing the records 72a in which customer IDs, information specifying products purchased by users corresponding to the customer IDs, and the dates of purchase of the products are associated with each other.

The sales management unit 43 generates and manages a product-information DB 81, an accepted-order-and-stock DB 82, and a payment DB 83.

The product-information DB 81 stores, for example, information regarding products handled by an online-shopping retailer. The accepted-order-and-stock DB 82 stores information indicating accepted orders and stock of each of the products. The payment DB 83 stores information regarding a payment status of each of ordered products.

Next, online shopping in the network system 10 will be specifically described. Processing for placing orders for products in the network system 10 is executed in accordance with the navigation function realized by the program recorded on the disc 12.

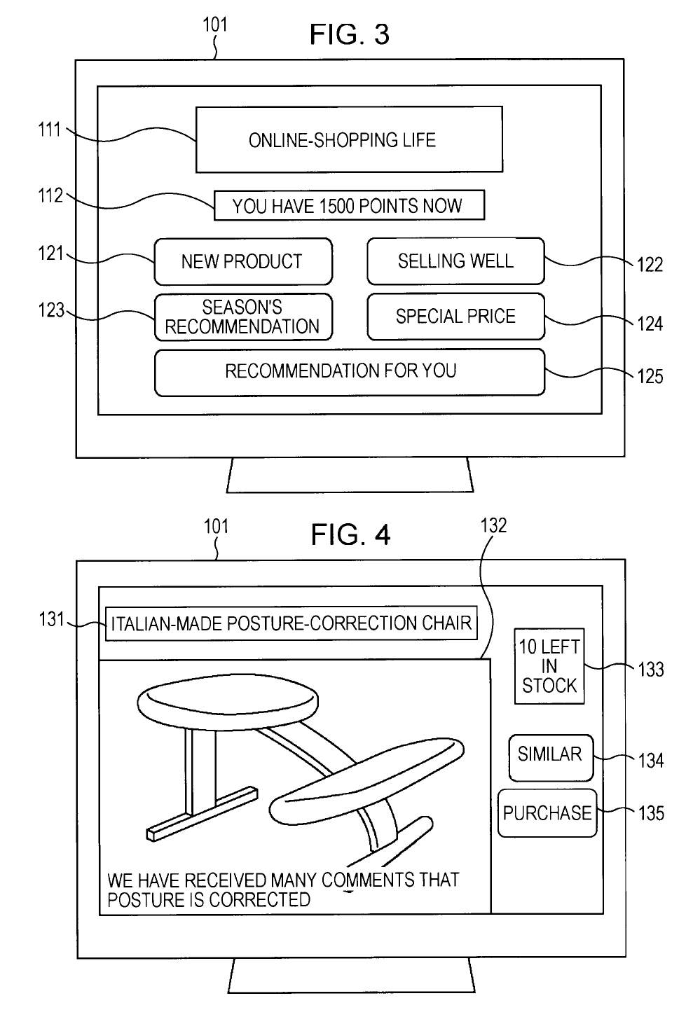

When a user inserts the disc 12 into the terminal 11, for example, a screen as shown in FIG. 3 is displayed on a display 101 connected to the terminal 11. In this example, “ONLINE-SHOPPING LIFE” is displayed in a region 111 on the screen of the display 101. In the region 111, for example, the name of a service provided by an online-shopping retailer is displayed.

Moreover, “YOU HAVE 1500 POINTS NOW” is displayed in a region 112 on the screen of the display 101. This is the information displayed as a result of the following: when the disc 12 is inserted, the disc ID of the disc 12 is sent to the server 14; the disc management unit 41 searches the disc DB 61 and specifies the customer ID corresponding to the disc ID; and the customer management unit 42 searches the customer DB 71 and specifies the acquired points corresponding to the customer ID.

Moreover, for example, buttons 121 through 125 are displayed as parts of a GUI on the screen of the display 101. In this example, “NEW PRODUCT” is displayed on the button 121, “SELLING WELL” is displayed on the button 122, “SEASON'S RECOMMENDATION” is displayed on the button 123, “SPECIAL PRICE” is displayed on the button 124, and “RECOMMENDATION FOR YOU” is displayed on the button 125. The strings of characters displayed on the buttons 21 through 125 correspond to the names of playback modes.

That is, when the button 121 is pressed through a remote controller or the like, which is not shown, for example, content items recorded on the disc 12 are played back in a “NEW PRODUCT” playback mode in which content items for introducing new products are mainly played back. Moreover, when the button 122 is pressed through the remote controller or the like, for example, content items recorded on the disc 12 are played back in a “SELLING WELL” playback mode in which content items for introducing products that have been ordered in large amounts in the previous one month are mainly played back.

Furthermore, when the button 123 is pressed through the remote controller or the like, for example, content items recorded on the disc 12 are played back in a “SEASON'S RECOMMENDATION” playback mode in which content items for introducing products suitable for the current season are mainly played back. Moreover, when the button 124 is pressed through the remote controller or the like, for example, content items recorded on the disc 12 are played back in a “SPECIAL PRICE” playback mode in which content items for introducing products whose prices have been lowered in the previous one month are mainly played back.

Furthermore, when the button 125 is pressed through the remote controller or the like, for example, content items recorded on the disc 12 are played back in a “RECOMMENDATION FOR YOU” playback mode in which content items for introducing products appropriate for a subject user's taste are mainly played back.

Such playback modes are controlled in accordance with the above-described playlists. The insertion of the disc 12 into the terminal 11 sends the disc ID of the disc 12 to the server 14, and the disc management unit 41 searches the disc DB 61 and specifies the customer ID corresponding to the disc ID. Then, pressing of one of the buttons 121 though 125 sends information specifying the name of corresponding one of the playback modes to the server 14. The disc management unit 41 searches the playlist DB 62, specifies the URI corresponding to the customer ID and playback mode, reads the playlist file 63 stored at the URI, and sends the playlist file 63 to the terminal 11, whereby content items are played back in the playback mode at the terminal 11.

For example, when the button 123 is pressed on the screen shown in FIG. 3, a screen as shown in FIG. 4 is displayed on the display 101 of the terminal 11.

In an example shown in FIG. 4, the name of a product is displayed in a region 131 on the screen of the display 101. In this example, “ITALIAN-MADE POSTURE-CORRECTION CHAIR” is displayed. Moreover, an image of a product is displayed together with a telop in a region 132 on the screen of the display 101. Here, an image of the product may be a moving image.

Furthermore, “10 LEFT IN STOCK” is displayed in a region 133 on the screen of the display 101. This is the information displayed as a result of the following: the sales management unit 43 of the server 14 searches the product-information DB 81 and the accepted-order-and-stock DB 82 and specifies the stock quantity of the product.

Moreover, buttons 134 and 135 are displayed as parts of a GUI on the screen of the display 101.

On the button 134, “SIMILAR” is displayed. When the button 134 is pressed through the remote controller or the like, for example, searching for content items for introducing products similar to a subject product (here, “ITALIAN-MADE POSTURE-CORRECTION CHAIR”) is performed from among content items recorded on the disc 12, and a list of content items obtained as a result of the search is displayed.

On the button 135, “PURCHASE” is displayed. When the button 135 is pressed through the remote controller or the like, for example, a command to order (purchase) a product is sent from the terminal 11 to the server 14 together with information specifying the subject product (here, “ITALIAN-MADE POSTURE-CORRECTION CHAIR”).

While content items recorded on the disc 12 are played back in accordance with one of the playlists, display of each of the regions on the screen of the display 101 is changed. That is, when playback of a content item for introducing a certain product is finished, a content item for introducing a next product is played back.

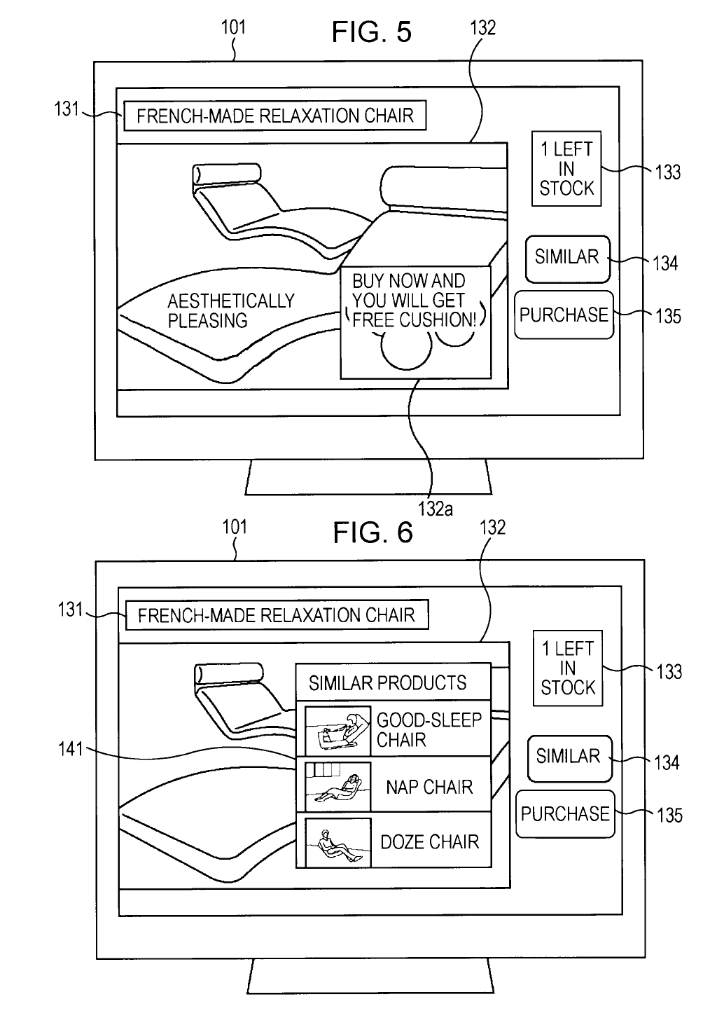

When content items recorded on the disc 12 are further played back from the state shown in FIG. 4 in accordance with one of the playlists, the screen displayed on the display 101 is changed to the screen shown in FIG. 5, for example.

In an example of FIG. 5, “FRENCH-MADE RELAXATION CHAIR” is displayed as the name of a product in the region 131 on the screen of the display 101. Moreover, an image of the product is displayed in the region 132 on the screen of the display 101 together with a telop. Moreover, in this example, display is performed in such a manner that a small screen 132a is superimposed on the image displayed in the region 132. Furthermore, “1 left in stock” is displayed in the region 133 on the screen of the display 101, and similarly to the case of FIG. 4, the buttons 134 and 135 are displayed.

Here, display is performed in such a manner that the small screen 132a is superimposed on the image displayed in the region 132 by means of, for example, a picture-in-picture (PinP) function.

For example, when the button 134 is pressed through the remote controller or the like in a state in which the screen shown in FIG. 5 is displayed, the screen displayed on the display 101 is changed to the screen shown in FIG. 6. In an example of FIG. 6, display is performed in such a manner that a list display screen 141 is superimposed on the image displayed in the region 132 on the screen. In the list display screen 141, a list of content items for introducing products similar to the product displayed in the region 132 is displayed. In this example, in the list display screen 141, a content item for introducing a product “GOOD-SLEEP CHAIR”, a content item for introducing a product “NAP CHAIR”, and a content item for introducing a product “DOZE CHAIR” are displayed in a list format.

For example, when a thumbnail image displayed on the list display screen 141 is pressed through the remote controller or the like, a content item corresponding to the thumbnail image is played back.

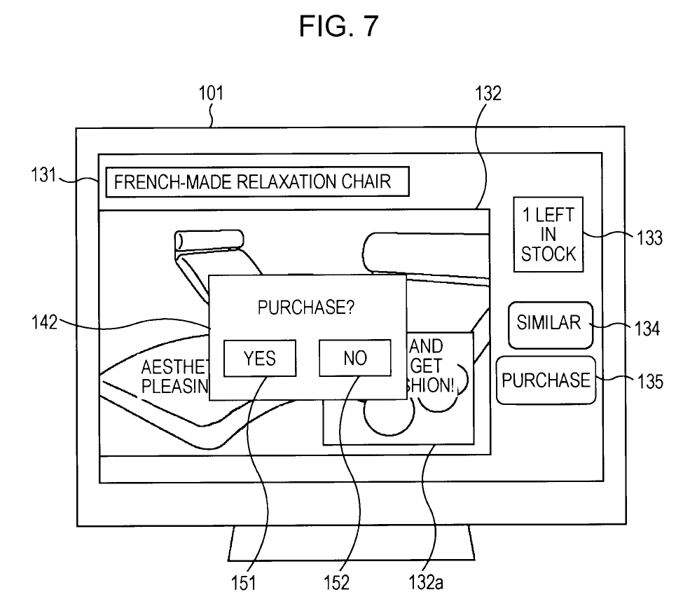

For example, in a state in which the screen shown in FIG. 5 is displayed, when the button 135 is pressed through the remote controller or the like, the screen displayed on the display 101 is changed to the screen shown in FIG. 7. In an example of FIG. 7, pressing of the button 135 displays a dialog box 142 which is superimposed on the image displayed in the region 132 on the screen. In the dialog box 142, a “YES” button 151 and a “NO” button 152 are displayed. For example, when the “YES” button 151 is clicked through the remote controller or the like, a command to order (purchase) a product is sent to the server 14 together with information specifying the product displayed in the region 132 (here, “FRENCH-MADE RELAXATION CHAIR”). When the “NO” button 152 is clicked through the remote controller or the like, the screen displayed on the display 101 returns to the state as shown in FIG. 5.

Here, as a matter of course, each of the screens described above with reference to FIGS. 4 through 7 may be displayed as a moving image. For example, similarly to a general moving-image content item, such a moving image can be paused, played back at fast speed, played back at slow speed, and the like through the remote controller or the like being operated by a user.

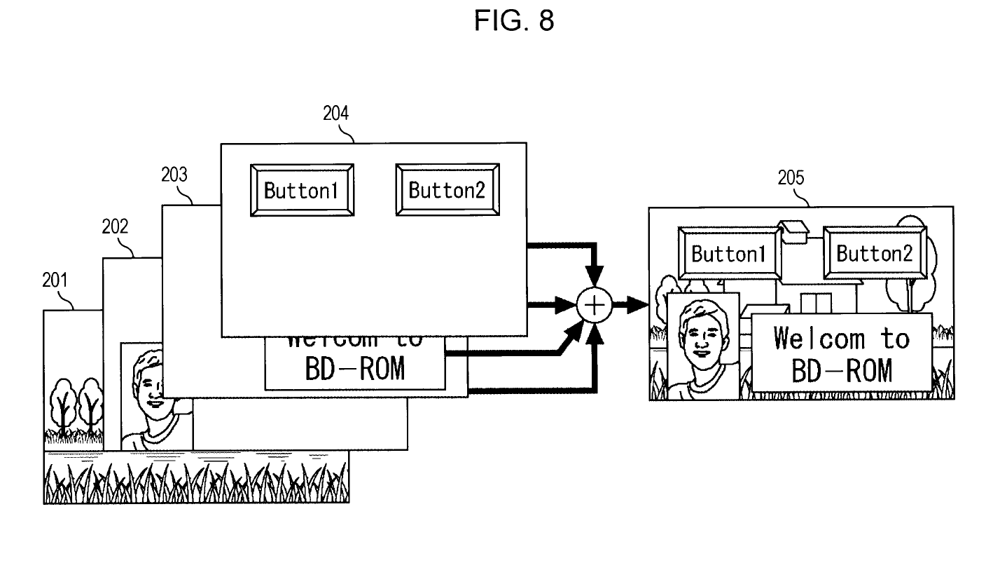

FIG. 8 is a diagram for describing generation of display data to be displayed on the screen of the display 101. An application program generates display data by combining a plurality of planes as shown in FIG. 8 as necessary.

In an example of FIG. 8, a primary video plane 201, a secondary video plane 202, a presentation graphics plane 203, and an interactive graphics plane 204 are combined, and an image 205 to be displayed on the display 101 is generated.

The primary video plane 201 includes, for example, an image obtained when a content item recorded on the disc 12 is played back. The secondary video plane 202 includes, for example, an image whose screen size is small, the image being obtained by reducing an image obtained when a content item recorded on the disc 12 is played back.

The presentation graphics plane 203 includes, for example, an image such as a message to be displayed on the screen of the display 101. The interactive graphics plane 204 includes, for example, images of parts (for example, buttons) and the like of a GUI.

For example, the dialog box 142, the “YES” button 151, and the “NO” button 152 in FIG. 7 are images included in an interactive graphics plane. Moreover, the region 133 (“10 LEFT IN STOCK”), the button 134, and the button 135 in FIG. 7 are images included in the interactive graphics plane.

The region 131 (“FRENCH-MADE RELAXATION CHAIR”) in FIG. 7 is an image included in a presentation graphics plane. The small screen 132a in FIG. 7 is displayed as an image included in a secondary video plane, and the image of the region 132 is displayed as an image included in a primary video plane.

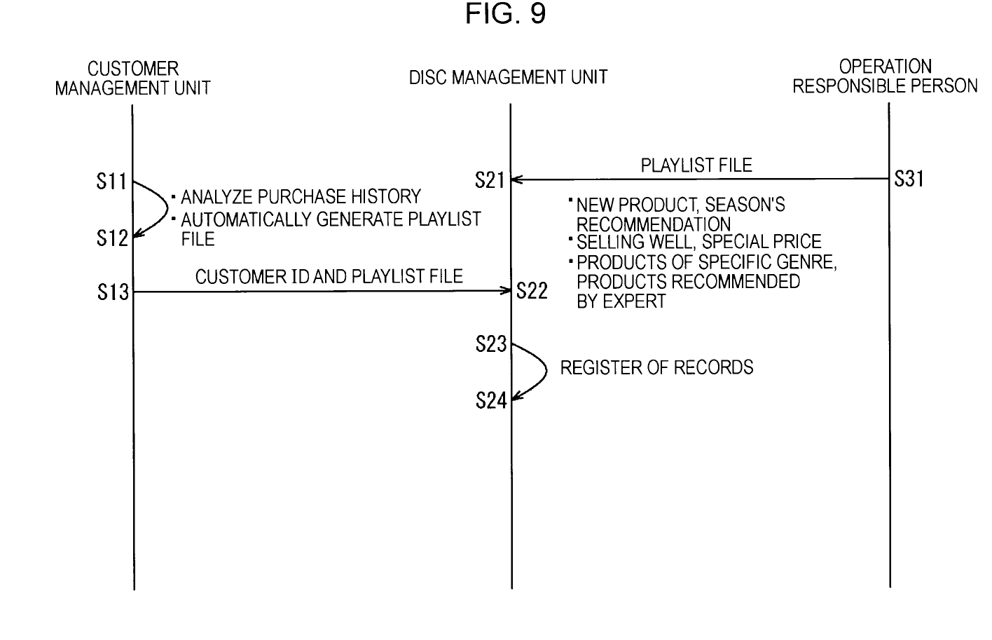

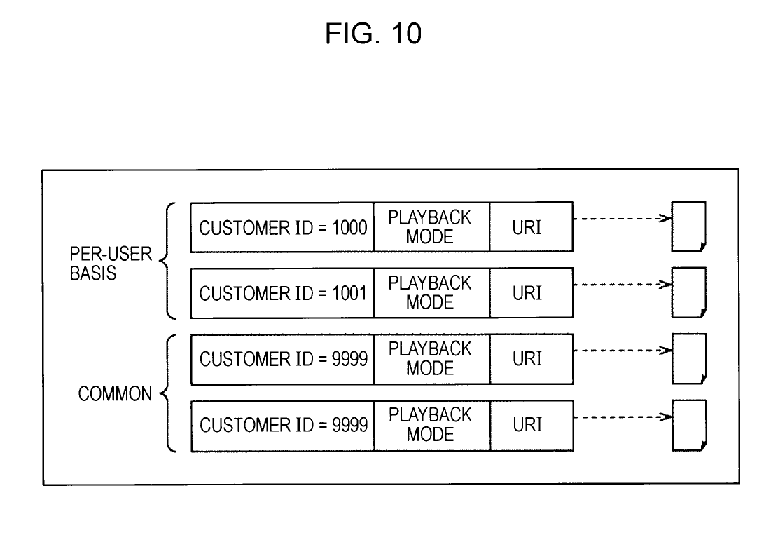

FIG. 9 is a sequence diagram for describing a procedure of processing for generating the above-described playlist files.

As shown in FIG. 9, there are a case in which playlist files are generated by a person responsible for the operation of the server 14 (hereinafter simply referred to as an “operation responsible person”) and a case in which playlist files are automatically generated by the customer management unit 42 of the server 14.

When playlist files are generated by the operation responsible person, in step S31, the operation responsible person generates the playlist files and supplies the playlist files to the disc management unit 41. In step S21, the disc management unit 41 receives the playlist files and the playlist files are recorded at predetermined positions on the recording medium of the server 14.

The playlist files generated in step S31 include, for example, a playlist file in which a playlist corresponding to the “NEW PRODUCT” playback mode is described, a playlist file in which a playlist corresponding to the “SELLING WELL” playback mode is described, a playlist file in which a playlist corresponding to the “SEASON'S RECOMMENDATION” playback mode is described, and a playlist file in which a playlist corresponding to the “SPECIAL PRICE” playback mode is described, the playback modes being described above with reference to FIG. 3.

That is, the playlist files generated by the operation responsible person in step S31 are playlist files in which playlists capable of being commonly used regardless of users' taste are described. Moreover, in step S31, a playlist file corresponding to a playback mode for mainly playing back content items for introducing products of a specific genre, or a playlist file corresponding to a playback mode for mainly playing back content items for introducing products recommended by an expert may be generated. For example, when the playback mode for mainly playing back content items for introducing products recommended by an expert is selected, content items recorded in the server 14 may be played back instead of content items recorded on the disc 12.

In contrast, when playlist files are automatically generated by the customer management unit 42, in step S11, the customer management unit 42 analyzes data stored in the purchase history DB 72. Then, in step S12, the customer management unit 42 generates playlist files on a per-user basis (a per-customer-ID basis).

In step S13, the customer management unit 42 supplies the playlist files generated in step S12 to the disc management unit 41. In step S22, the disc management unit 41 receives the playlist files, and the playlist files are recorded at predetermined positions on the recording medium of the server 14.

The playlist files generated in step S12 are, for example, playlist files in which playlists corresponding to the “RECOMMENDATION FOR YOU” playback mode are described, the playback mode being described above with reference to FIG. 3. In the “RECOMMENDATION FOR YOU” playback mode, content items for introducing products appropriate for a subject user's taste are mainly played back. Thus, in step S11, the purchase history of each of the customer IDs (users) is analyzed. In step S12, playlists are generated on a per-customer-ID basis (a per-user basis). In step S13, playlist files of the playlists are associated with customer IDs, and the playlist files are supplied to the disc management unit 41.

In step S23, the disc management unit 41 generates records to be stored in the playlist DB 62 in accordance with the playlist files obtained in steps S21 and S22. In step S24, the disc management unit 41 stores the records in the playlist DB 62.

Thus, for example, a group of records as shown in FIG. 10 are stored in the playlist DB 62. As described above, the records stored in the playlist DB 62 include customer IDs, playback modes, and URIs. For example, the playlist files obtained in step S22 are different between users, and thus, as shown in FIG. 10, the URI of each of the playlist files is stored being associated with the customer ID of a corresponding one of the users and a playback mode. In contrast, the playlist files obtained in step S21 are common for all users. As shown in FIG. 10, for example, a customer ID “9999” that is common to all the users is assigned to the URI of each of the playlist files and the playlist files are stored being associated with playback modes.

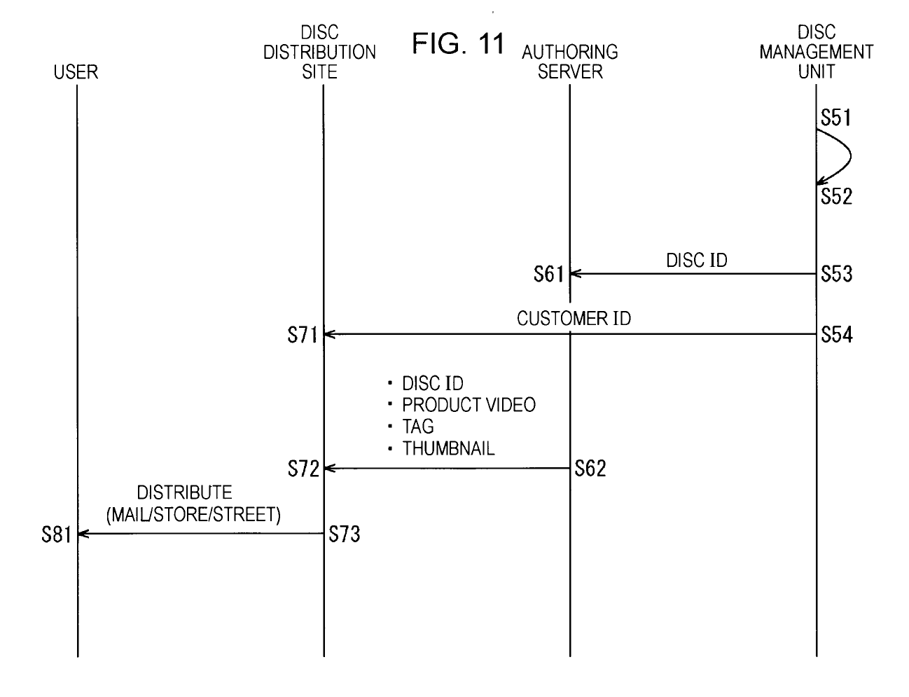

FIG. 11 is a sequence diagram for describing a procedure of processing for distributing discs 12.

In step S51, the disc management unit 41 generates records, each of which includes a disc ID and a corresponding customer ID. In step S52, the disc management unit 41 stores the records in the disc DB 61. Here, for example, a record in which a disc ID “A000” and a customer ID “1000” are associated with each other is generated and stored.

In step S53, the disc management unit 41 sends the disc IDs (an example of which is “A000”), which are associated with the customer IDs, to the authoring server 16. In step S61, the authoring server 16 obtains the disc IDs.

In step S54, the disc management unit 41 sends the customer IDs (an example of which is “1000”), which are associated with the disc IDs sent in step S53, to a site from which discs are distributed (hereinafter simply referred to as a “disc distribution site”). In step S71, the disc distribution site obtains the customer IDs.

In step S62, the authoring server 16 edits each data to be recorded on a corresponding one of the discs 12 and sends the data to the disc distribution site, the each data including one of the disc IDs obtained in step S61. In step S72, the disc distribution site obtains the data. Here, the data to be recorded on the disc 12 is edited to include, other than the disc ID, data such as a video regarding a product, various tag information, a thumbnail image, and the like.

In step S73, at the disc distribution site, the data obtained in step S72 is recorded on the disc 12, and the disc 12 is distributed to the user corresponding to the customer ID (for example, “A000”) obtained in step S71. In step S81, the user obtains the disc 12.

Here, in an example of FIG. 11, the each data is recorded on a corresponding one of the discs 12 at the disc distribution site; however, the each data may be recorded on the corresponding one of the discs 12 at a different site.

In this way, the discs 12 are distributed.

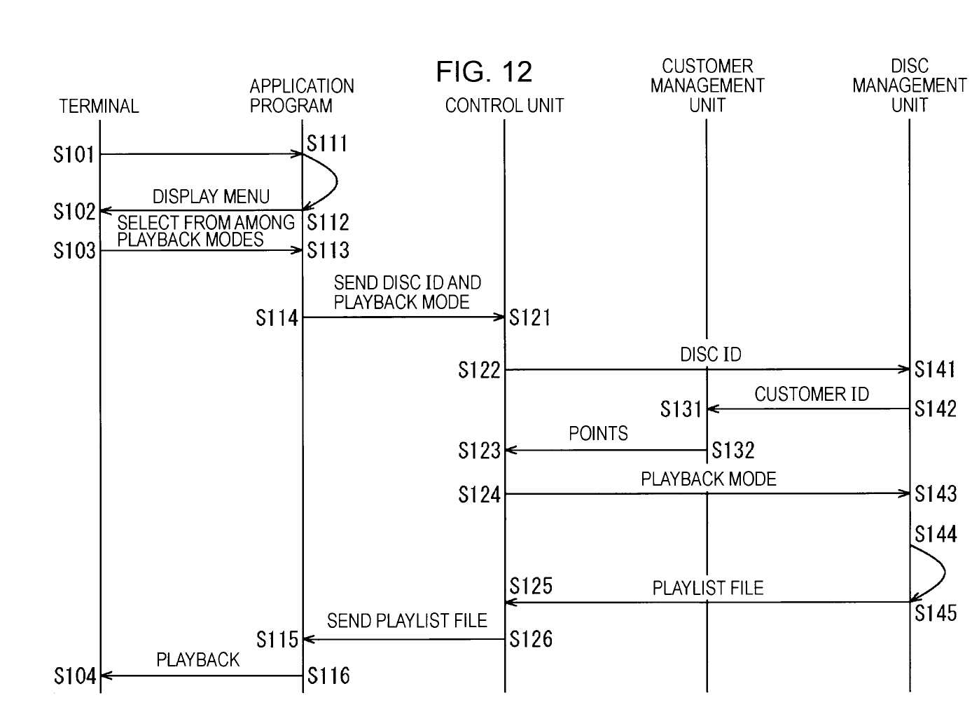

FIG. 12 is a sequence diagram for describing a procedure of processing regarding playback of content items recorded on the disc 12.

In step S101, the disc 12 is inserted into the terminal 11. In step S111, an application program (for example, the above-described BD-J) recorded on the disc 12 is started.

In step S112, the application program generates, for example, display data of a menu screen. In step S102, this menu screen is displayed on the display of the terminal 11. Here, for example, the screen as shown in FIG. 3 is displayed on the display of the terminal 11.

In step S103, the terminal 11 receives a playback mode selected by a user through the screen displayed on the display. In step S113, the application program obtains information specifying the selected playback mode.

In step S114, the application program sends the disc ID of the disc 12 and the information specifying the playback mode obtained in step S113 to the server 14. In step S121, the control unit 31 of the server 14 obtains them.

In step S122, the control unit 31 supplies the disc ID obtained in step S121 to the disc management unit 41. In step S141, the disc management unit 41 obtains the disc ID.

In step S142, the disc management unit 41 searches the disc DB 61 in accordance with the disc ID obtained in step S141, specifies the customer ID corresponding to the disc ID, and supplies the customer ID to the customer management unit 42.

In step S131, the customer management unit 42 obtains the customer ID, and the customer management unit 42 searches the customer DB 71 in accordance with the customer ID and specifies acquired points of the customer ID. In step S132, the customer management unit 42 supplies the acquired points to the control unit 31. In step S123, the control unit 31 obtains the acquired points.

In step S124, the control unit 31 supplies the information specifying the playback mode obtained in step S121 to the disc management unit 41. In step S143, the disc management unit 41 obtains the information.

In step S144, the disc management unit 41 searches the playlist DB 62 in accordance with the customer ID specified in step S142 and the information specifying the playback mode obtained in step S143, and specifies the URI of a playlist file 63 to be sent.

In step S145, the disc management unit 41 reads the playlist file 63 from the recording medium of the server 14 in accordance with the URI specified in processing in step S144, and supplies the playlist file 63 to the control unit 31. In step S125, the control unit 31 obtains the playlist file 63.

In step S126, the control unit 31 sends the playlist file 63 obtained in step S125 to the terminal 11. In step S115, the application program of the terminal 11 receives the playlist file 63.

In step S116, the application program starts control of playback of content items recorded on the disc 12, in accordance with the playlist file 63 obtained in step S115. In step S104, the terminal 11 plays back the content items recorded on the disc 12. Here, for example, a screen such as the screens as described above with reference to FIGS. 4 and 5 is displayed on the display of the terminal 11.

Here, in the sequence diagram of FIG. 12, the terminal 11 and the application program are described as individuals in such a manner that they individually execute processing; however, as described above, the application program which is recorded in advance on the disc 12 is executed by the control unit 21 of the terminal 11 when the disc 12 is played back, whereby processing performed by the application program in the sequence diagram of FIG. 12 is practically executed by the terminal 11.

Furthermore, in the sequence diagram of FIG. 12, the control unit 31, the disc management unit 41, and the customer management unit 42 of the server 14 are described as individuals in such a manner that they individually execute processing; however, as described above, the disc management unit 41 and the customer management unit 42 are functional blocks realized by software such as a program executed by the control unit 31, whereby processing performed by the disc management unit 41 and processing performed by the customer management unit 42 in the sequence diagram of FIG. 12 are practically executed by the control unit 31.

In this way, processing regarding playback of the content items recorded on the disc 12 is executed. The playback of content items recorded on the disc 12 is controlled in accordance with the playlist file 63 sent from the server 14. Thus, for example, an image, audio, and the like that are particularly desired to be provided to a user can be played back from data of a large amount recorded on the disc 12, the data including images, audio, and the like.

So-called existing television shopping has a problem in that if a television program which is broadcasted at a predetermined time period is not viewed, orders for products are not placed, whereby cost effectiveness is low.

In contrast, according to an embodiment of the present invention, a user can start shopping by playing back the disc 12 using the terminal 11 at the user's convenience. Thus, the user can enjoy shopping without being tied to a specific schedule.

Moreover, existing mail order has a problem in that mail order does not adequately convey product details and maintain information freshness.

In contrast, according to an embodiment of the present invention, playback of content items recorded on the disc 12 is controlled in accordance with the playlist file 63 sent from the server 14. Thus, for example, a product to be introduced can be changed by simply rewriting the playlist file 63, whereby product details are more adequately conveyed and information freshness is more properly maintained.

Moreover, existing Internet shopping can sell products regardless of time frame and can maintain information freshness. However, for example, it is difficult to provide high-quality content regarding images of a product to be introduced because of the constraints of a network transmission speed. Thus, in comparison with, for example, so-called television shopping, the Internet shopping does not adequately convey product details.

In contrast, according to an embodiment of the present invention, the data of content items that includes image data whose data amount is very large is recorded in advance on the disc 12 and playback of the content items recorded on the disc 12 is controlled in accordance with the playlist file 63 sent from the server 14. Thus, an influence of a network transmission speed and the like becomes smaller and product details can be more powerfully conveyed to any user.

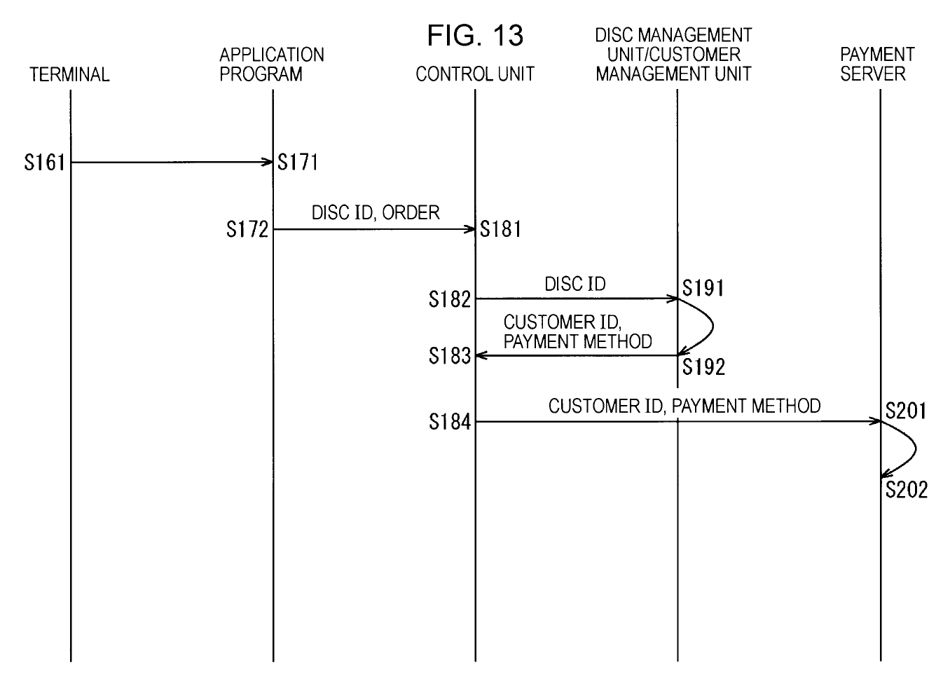

FIG. 13 is a sequence diagram for describing a procedure of processing in a case where the disc 12 is played back by the terminal 11 and an order for a product is placed.

In step S161, the terminal 11 sends, to the application program, a notification that an order for a product is received. Here, for example, the “YES” button 151 is clicked on the screen of FIG. 7.

In step S171, the application program receives the notification from the terminal 11. In step S172, the disc ID of the disc 12, the information specifying the product, and a command to order (purchase) the product are sent to the server 14. In step S181, the control unit 31 of the server 14 receives them.

In step S182, the control unit 31 supplies the disc ID received in step S181 to the disc management unit 41. In step S191, the disc management unit 41 receives the disc ID.

In step S192, the disc management unit 41 searches the disc DB 61 in accordance with the disc ID and specifies the customer ID which corresponds to the disc ID, and the customer management unit 42 searches the customer DB 71 in accordance with the customer ID and specifies a payment method which corresponds to the customer ID. The specified customer ID and payment method are supplied to the control unit 31. In step S183, the control unit 31 receives them.

In step S184, to the payment server 15, the control unit 31 sends the customer ID and payment method obtained in step S183 and sends a command to perform payment processing regarding the charge for the product. In step S201, the payment server 15 receives them. In step S202, payment processing regarding the charge for the product is executed.

Here, in the sequence diagram of FIG. 13, the terminal 11 and the application program are described as individuals in such a manner that they individually execute processing; however, as described above, the application program which is recorded in advance on the disc 12 is executed by the control unit 21 of the terminal 11 when the disc 12 is played back, whereby processing performed by the application program in the sequence diagram of FIG. 13 is also practically executed by the terminal 11.

Furthermore, in the sequence diagram of FIG. 13, the control unit 31, the disc management unit 41, and the customer management unit 42 of the server 14 are described as individuals in such a manner that they individually execute processing; however, as described above, the disc management unit 41 and the customer management unit 42 are functional blocks realized by software such as a program executed by the control unit 31, whereby processing performed by the disc management unit 41 and processing performed by the customer management unit 42 in the sequence diagram of FIG. 13 are also practically executed by the control unit 31.

In this way, processing in a case where the disc 12 is played back by the terminal 11 and an order for a product is placed is executed. In this way, in an embodiment of the present invention, while content items are played back, when a user finds a product he or she likes, the user can easily place an order for the product.

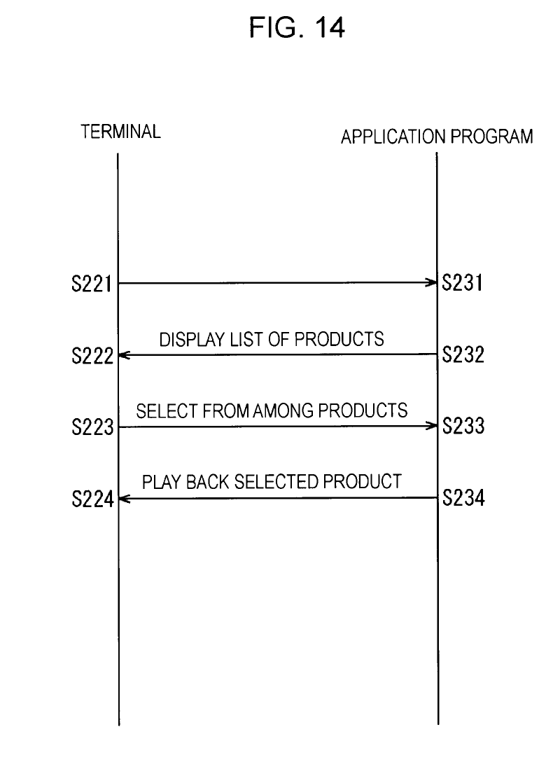

FIG. 14 is a sequence diagram for describing a procedure of processing in a case where the disc 12 is played back by the terminal 11 and a content item for introducing a product is played back while a content item for introducing another product is being played back.

In step S221, the terminal 11 accepts, for example, an operation through the button 134 on the screen shown in FIG. 5, and sends a notification that the button 134 has been operated, to the application program.

In step S231, the application program receives the notification from the terminal 11. In step S232, for example, the application program searches for content items for introducing products that are similar to the product displayed in the region 132 of FIG. 5, and controls display of a list of content items obtained as a result of the search.

In step S222, display is performed in such a manner that, for example, the list display screen 141 displaying a list of content items for introducing products that are similar to the product displayed in the region 132 of FIG. 5 is superimposed on the region 132 displayed on the terminal 11. Here, for example, the screen as shown in FIG. 6 is displayed on the display of the terminal 11.

In step S223, the terminal 11 accepts selection of a content item, the selection being performed through the list display screen 141, and sends information specifying the selected content item, as a notification, to the application program.

In step S233, the application program receives the notification sent from the terminal 11. In step S234, the application program controls playback of the selected content item. In step S224, the terminal 11 plays back the content item. Thus, one of the content items displayed on the list display screen 141 (in the example of FIG. 6, one of the content item for introducing the product “GOOD-SLEEP CHAIR”, the content item for introducing the product “NAP CHAIR”, and the content item for introducing the product “DOZE CHAIR”) is played back and an image of the played-back content item is displayed in the region 132.

Here, the products that are introduced as products similar to a subject product may be products whose application purpose is the same as that of the subject product or products manufactured by the same manufacturer as the subject product. In addition, products whose color or price range is the same as that of the subject product may be introduced as products similar to the subject product.

In this way, processing in a case where a content item for introducing a product is played back while a content item for introducing another product is being played back is executed. As a result, a user can select a product with a higher degree of freedom.

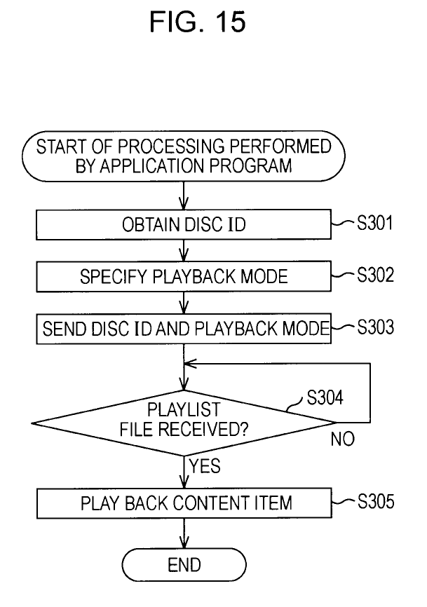

Next, with reference to a flowchart of FIG. 15, processing performed by the application program in FIG. 12 will be more specifically described. This processing is executed when the disc 12 is inserted into the terminal 11.

In step S301, the application program obtains the disc ID of the disc 12.

In step S302, the application program generates, for example, display data of the menu screen, accepts a playback mode selected by a user through the screen displayed on the display, and specifies the selected playback mode. Here, this processing is processing corresponding to step S113 of FIG. 12.

In step S303, the application program sends the disc ID obtained in step S301 and the playback mode specified in step S302 to the server 14. Here, this processing is processing corresponding to step S114 of FIG. 12.

In step S304, the application program determines whether the playlist file 63 has been received from the server 14. The procedure stops in step S304 until the application program determines that the playlist file 63 has been received. In step S304, if the application program determines that the playlist file 63 has been received, the procedure proceeds to step S305.

In step S305, the application program plays back a content item recorded on the disc 12 in accordance with the playlist file 63, which is determined that it has been received in processing in step S305. Here, this processing is processing corresponding to step S116 of FIG. 12.

In this way, processing performed by the application program is executed.

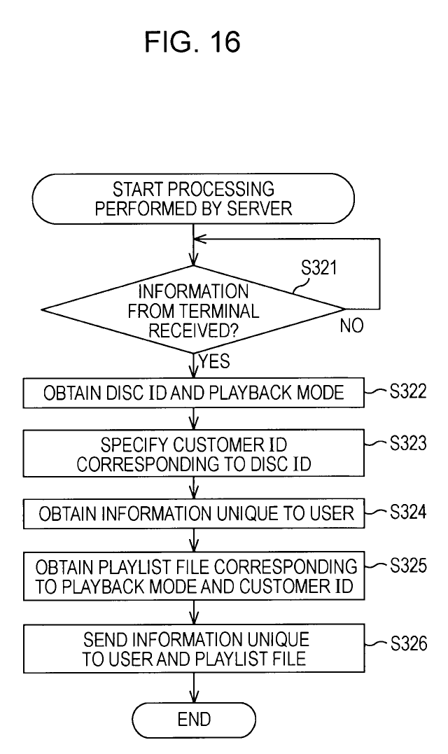

Next, with reference to a flowchart of FIG. 16, processing performed by the server 14 (processing performed by the control unit, processing performed by the customer management unit, and processing performed by the disc management unit) in FIG. 12 will be more specifically described.

In step S321, the control unit 31 of the server 14 determines whether information from the terminal 11 has been received. The procedure stops in step S321 until the control unit 31 determines that the information from the terminal 11 has been received. If the control unit 31 determines that the information from the terminal 11 has been received, the procedure proceeds to step S322.

In step S322, the control unit 31 obtains the disc ID and the playback mode included in the information sent from the terminal 11.

In step S323, the disc management unit 41 searches the disc DB 61 and specifies the customer ID corresponding to the disc ID obtained in step S322. Here, this processing is processing corresponding to steps S141 and S142 of FIG. 12.

In step S324, the customer management unit 42 searches the customer DB 71 in accordance with the customer ID specified in processing in step S323, and obtains, for example, information unique to a subject user such as acquired points.

In step S325, the disc management unit 41 searches the playlist DB 62 in accordance with the playback mode obtained in processing in step S322 and the customer ID specified in processing in step S323, specifies the URI of a playlist file 63 to be sent, and obtains the playlist file 63. Here, this processing is processing corresponding to step S144 of FIG. 12.

In step S326, the control unit 31 sends the information unique to the subject user obtained in processing in step S324 and the playlist file 63 obtained in processing in step S325 to the terminal 11. Here, this processing is processing corresponding to step S126 of FIG. 12.

In this way, processing performed by the server 14 is executed.

In the above, an example in which predetermined products are mainly sold through online shopping using the network system 10 is described; however, as a matter of course, predetermined services may be sold through online shopping.

Alternatively, a trip may be booked through the network system 10. In this case, for example, the discs 12 may be distributed to users from a dealer such as a travel agency, and the playlist file 63 may be generated. This may more strongly motivate users to arrange a trip, compared with an existing case in which, for example, tour brochures are distributed to the users.

Moreover, a ticket for a concert may be booked through the network system 10.

Alternatively, the network system 10 may be simply used to introduce products or services instead of using it for online shopping. For example, before making a decision on buying an expensive item such as a car or a house, a content item for such an expensive item may be viewed through the network system 10.

In the above, an embodiment of the present invention has been described using, as an example, a case in which a navigation function realized by the BD-J when a BD is played back; however, as a matter of course, an embodiment of the present invention may be applied to other cases using a navigation function realized by a program other than the BD-J.

Moreover, in the above, description has been made assuming that the disc 12 is inserted into the terminal 11; however, a disc-shaped recording medium does not have to be inserted into the terminal 11 on every occasion. An embodiment of the present invention may be applied to a case where a recording medium such as a Universal Serial Bus (USB) memory, an integrated circuit (IC) card, or the like is used.

Furthermore, in the above, description has been made in such a manner that the playlist files 63 are generated and recorded in advance on the recording medium of the server 14 by, for example, the person responsible for the operation of the server 14; however, for example, playlists may be generated in the terminal 11. In this case, it is necessary that the terminal 11 receives, instead of the playlist files 63, information necessary to generate the playlists from the server 14, and generate the playlists using the received information.

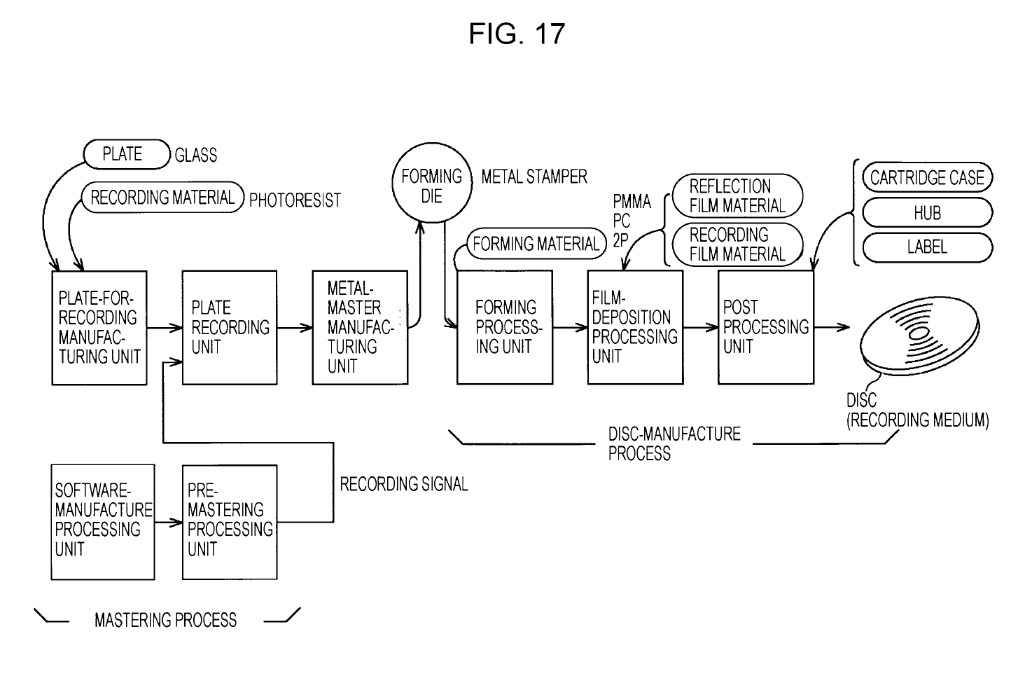

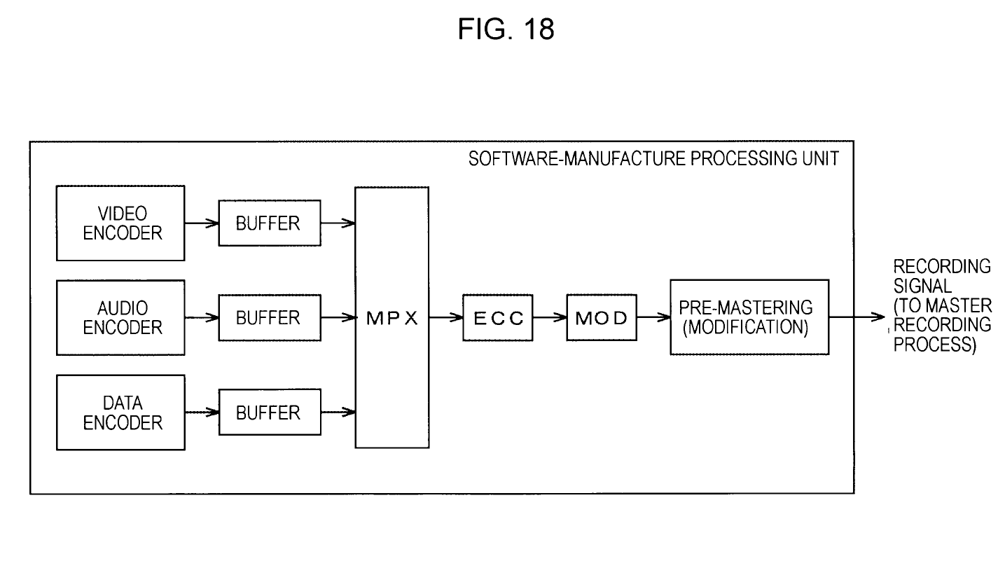

Next, with reference to FIGS. 17 and 18, an exemplary method for manufacturing the discs 12, which are recording media on which data that can be played back by the terminal 11 is recorded will be described.

That is, as shown in FIG. 17, for example, a plate made of glass is prepared, and a recording material composed of a photoresist is applied thereon. In this way, a plate for recording is manufactured.

As shown in FIG. 18, in a software-manufacture processing unit, video data that is encoded by an encoding apparatus (a video encoder) and provided in a format that can be played back by the terminal 11 is stored in a temporary buffer. Similarly, audio data encoded by an audio encoder is stored in a temporary buffer, and data other than streams of data (for example, Indexes, Playlist, PlayItem, and the like) is stored in a temporary buffer. The video data, the audio data, and the data other than the streams of data that are stored in the temporary buffers are multiplexed together with a synchronization signal by a multiplexer (MPX), and an error-correction code is added to the multiplexed data by an error-correction encoder (ECC). Then, predetermined modulation is performed on the resulting data by a modulator (MOD), and the resulting data is temporarily recorded on, for example, a magnetic tape in accordance with a predetermined format, whereby software to be recorded on a recording medium that can be played back by the terminal 11 is manufactured.

This software is modified (pre-mastered) as necessary, and a signal provided in a format to be recorded on an optical disc is generated. Then, as shown in FIG. 17, a laser beam is modulated in accordance with this recording signal, and the photoresist provided on the glass plate is irradiated with this laser beam. In this way, the photoresist provided on the glass plate is exposed to light in accordance with the recording signal.

Thereafter, this glass plate with the photoresist is developed to cause pits to appear thereon. On a glass master prepared in this way, processing such as electroforming or the like is performed and a metal master on which the pits that appear on the glass master are reprinted is manufactured. A metal stamper is manufactured from this metal master, and this metal stamper is used as a forming die.

For example, by way of injection, a material such as polymethylmethacrylate (PMMA) or polycarbonate (PC) is injected into this forming die and immobilized. Alternatively, 2P, which is a UV curable resin, is applied to the metal stamper, irradiated with ultraviolet rays, and cured. In this way, the pits provided on the metal stamper are reprinted onto a replica made of a resin.

On a replica manufactured in this way, a reflection film is formed by vapor deposition or a spattering method. Such a reflection film may be formed on a manufactured replica by a spin coating method.

Thereafter, the inside and outside diameters of this disc are processed, and a necessary process such as gluing two discs and the like is performed. Furthermore, a label is adhered, a hub is attached, and the resulting disc is inserted into a cartridge. In this way, a recording medium on which data that can be played back by the terminal 11 is recorded is obtained.

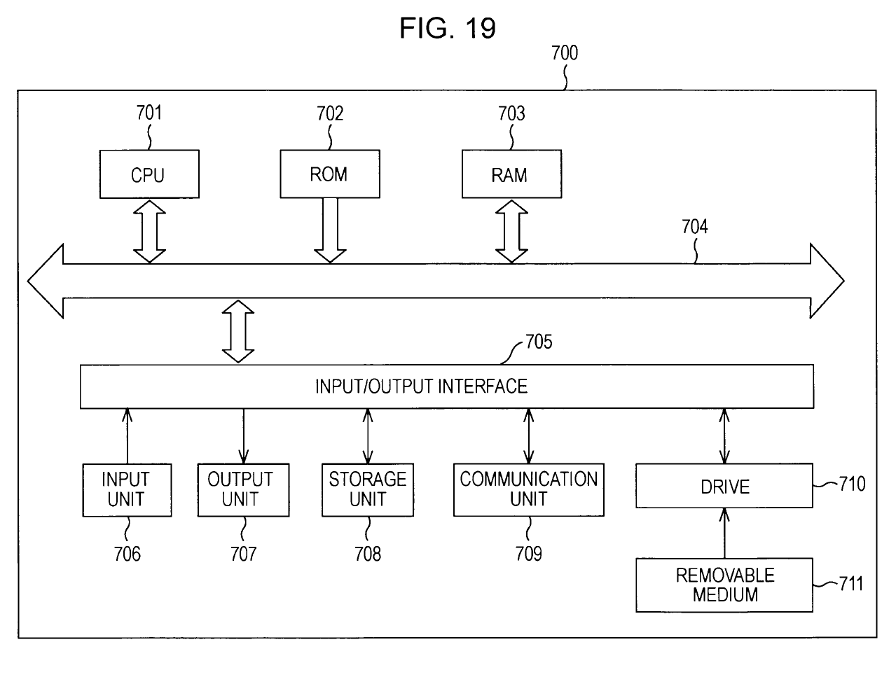

Here, a series of processing processes described above may be executed by hardware and may also be executed by software. In a case where the series of processing processes is executed by software, programs constituting the software are installed from a network or a recording medium onto a computer that is built in dedicated hardware or a general-purpose personal computer 700 capable of executing various functions with various programs being installed, for example, as shown in FIG. 19.

That is, the terminal 11, the server 14, and the like of FIG. 1 may be configured as shown in, for example, FIG. 19.

In FIG. 19, a central processing unit (CPU) 701 executes various processes in accordance with a program stored in a read-only memory (ROM) 702 or a program that is loaded into a random access memory (RAM) 703 from a storage unit 708. In the RAM 703, data that is necessary for the CPU 701 to execute various processes is stored as necessary.

The CPU 701, the ROM 702, and the RAM 703 are connected to each other via a bus 704. An input-output interface 705 is also connected to this bus 704.

To the input-output interface 705, an input unit 706 including a key board and a mouse, an output unit 707 including a display such as a cathode-ray tube (CRT) or a liquid crystal display (LCD) and a speaker, the storage unit 708 including a hard disk, a communication unit 709 including a modem, a network interface card such as a LAN card, and the like are connected. The communication unit 709 performs communication via a network including the Internet.

To the input-output interface 705, a drive 710 is connected as necessary. A removable medium 711 such as a magnetic disk, an optical disc, a magneto-optical disk, or a semiconductor memory is inserted into the drive 710 as necessary, and a computer program read from the removable medium is installed onto the storage unit 708 as necessary.

In a case where the above-described series of processing processes is executed by software, programs constituting the software are installed from a network such as the Internet or a recording medium including the removable medium 711.

Here, examples of such a recording medium may be not only the removable medium 711, as shown in FIG. 19, which is provided in addition to an apparatus and distributed to provide the program recorded thereon to users but also the ROM 702 and the hard disk included in the storage unit 708 which are built in an apparatus and on which a program to be provided to users is recorded. Here, examples of the removable medium 711 include a magnetic disk (including a floppy disk), an optical disc (including a compact disc-read-only memory (CD-ROM) and a digital versatile disc (DVD)), a magneto-optical disk (including a MiniDisc (MD) (registered trademark)), and a semiconductor memory.

Here, steps executing the series of processing processes described herein may be performed in chronological order in accordance with the described order, and may also be performed in parallel or individually instead of chronological order.

The present application contains subject matter related to that disclosed in Japanese Priority Patent Application JP 2008-100235 filed in the Japan Patent Office on Apr. 8, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A playback method for playing back data of a content item recorded on a recording medium in accordance with a control file sent from a server through communication, the playback method comprising the steps of:
obtaining medium specifying information specifying the recording medium;
specifying a playback mode of a content item recorded on the recording medium;
sending the medium specifying information and information specifying the playback mode to the server; and
receiving a control file sent by the server in accordance with the sent medium specifying information and the sent information specifying the playback mode and controlling playback of the content item recorded on the recording medium in accordance with the control file.

2. The playback method according to claim 1,
wherein a plurality of content items for introducing products or services are recorded on the recording medium, and
playback of the content items is controlled in a predetermined playback order or at a predetermined playback position in accordance with the control file sent from the server.

3. The playback method according to claim 2, further comprising the step of:
sending information specifying a product or a service for which an order is placed, to the server through a network in accordance with a user command.

4. The playback method according to claim 3,
wherein a control file generated in accordance with a purchase history of a user regarding the products and services is received from the server, the user being associated with the medium specifying information, and playback of the content items recorded on the recording medium is controlled in accordance with the control file.

5. A playback apparatus that communicates with a server and plays back data of a content item in accordance with a control file sent from the server, the playback apparatus comprising:
medium-information obtaining means for obtaining medium specifying information specifying a recording medium inserted into the medium-information obtaining means;
playback-mode specifying means for specifying a playback mode of a content item recorded on the recording medium;
sending means for sending the medium specifying information and information specifying the playback mode to the server; and
playback control means for receiving a control file sent by the server in accordance with the sent medium specifying information and the sent information specifying the playback mode and controlling playback of the content item recorded on the recording medium in accordance with the control file.

6. A recording medium on which data of a content item to be played back by a playback apparatus and a program for causing the playback apparatus to execute processing for playing back the content item are recorded, the program comprising the steps of:
obtaining and sending medium specifying information specifying the recording medium and information specifying a playback mode of a content item recorded on the recording medium, to the server via the playback apparatus; and
causing the playback apparatus to receive a control file sent by the server in accordance with the sent medium specifying information and the sent information specifying the playback mode and execute processing for playing back the content item recorded on the recording medium in accordance with the control file.

7. A server for supplying a control file for controlling playback of a content item to a playback apparatus into which a recording medium on which the content item is recorded is inserted, the server comprising:
obtaining means for obtaining medium specifying information specifying the recording medium and information specifying a playback mode of the content item that are included in information received from the playback apparatus; and
sending means for sending the control file, which is appropriate for the playback apparatus, to the playback apparatus in accordance with the obtained medium specifying information and the obtained information specifying the playback mode.

8. A control-file supplying method for supplying a control file for controlling playback of a content item to a playback apparatus into which a recording medium on which the content item is recorded is inserted, the control-file supplying method comprising the steps of:
obtaining medium specifying information specifying the recording medium and information specifying a playback mode of the content item that are included in information received from the playback apparatus; and
sending the control file, which is appropriate for the playback apparatus, to the playback apparatus in accordance with the obtained medium specifying information and the obtained information specifying the playback mode.

9. A recording medium on which a program is recorded, the program causing a server for supplying a control file for controlling playback of a content item to a playback apparatus into which a recording medium on which the content item is recorded is inserted, to execute the steps of:
obtaining medium specifying information specifying the recording medium and information specifying a playback mode of the content item that are included in information received from the playback apparatus; and
sending the control file, which is appropriate for the playback apparatus, to the playback apparatus in accordance with the obtained medium specifying information and the obtained information specifying the playback mode.

10. A playback apparatus that communicates with a server and plays back data of a content item in accordance with a control file sent from the server, the playback apparatus comprising:
a medium-information obtaining unit that obtains medium specifying information specifying a recording medium inserted into the medium-information obtaining unit;
a playback-mode specifying unit that specifies a playback mode of a content item recorded on the recording medium;
a sending unit that sends the medium specifying information and information specifying the playback mode to the server; and
a playback control unit that receives a control file sent by the server in accordance with the sent medium specifying information and the sent information specifying the playback mode and controls playback of the content item recorded on the recording medium in accordance with the control file.

11. A server for supplying a control file for controlling playback of a content item to a playback apparatus into which a recording medium on which the content item is recorded is inserted, the server comprising:
an obtaining unit that obtains medium specifying information specifying the recording medium and information specifying a playback mode of the content item that are included in information received from the playback apparatus; and
a sending unit that sends the control file, which is appropriate for the playback apparatus, to the playback apparatus in accordance with the obtained medium specifying information and the obtained information specifying the playback mode.
